(19) United States
(12) Patent Application Publication
(10) Pub. No.: US 2005/0239959 A1
(43) Pub. Date: Oct. 27, 2005

(54) Concrete surfacing method

(76) Inventors: Osamu Hisashi, Tokyo (JP); Kenichi Michiwaki, Tokyo (JP); Masami Motouri, Kanagawa (JP); Akira Yoshizumi, Kanagawa (JP)

Correspondence Address: JOSEPH G CURATOLO, ESQ.;CURATOLO SIDOTI CO. LPA, 24500 CENTER RIDGE ROAD, SUITE 280, CLEVELAND, OH, 44145, US

(21) Appl. No.: 10/515,962

(22) PCT Filed: May 26, 2003
(86) PCT No.: PCT/EP03/05517

§ 371 Date: Jun. 17, 2005

(30) Foreign Application Priority Data
May 30, 2002 (JP) 2002-157987

(51) Int. Cl. B05D 3/00; C08K 3/00

(52) U.S. Cl. 524/871; 427/298

(57) ABSTRACT

A method for improving the adhesiveness between hardened cement compositions and resin coating materials by spraying an aqueous solution containing organic acid(s) which will react with the surface to produce calcium compounds on the hardened cement surface before a resin coating material is applied, thus removing the carbonate membrane of hydrated cement compositions. This improves the adhesiveness between the hardened cement compositions and the resin coating material.

The present invention relates to a method for forming a resin layer by coating a resin material on the surface of a hardened cement composition for the purpose of corrosion resistance, waterproofing, decoration, etc., to a reforming method for the surface of hardened cement compositions for improving the adhesiveness of resin coating materials, and to a surface reformer used in these methods.

Conventional techniques are performed in which the surface of hardened cement compositions such as cement paste, mortar, concrete, etc. is lined with a resin coating material such as urethane resin, epoxy resin, acryl resin, vinyl ester resin. etc. for the purpose of corrosion resistance, waterproofing, decoration, etc. In general, these techniques are performed by coating with a primer comprising a resin coating material on the surface of hardened concrete to which a float finish has been applied, and by subsequently coating with a resin coating material. However, a primer cannot easily penetrate the concrete of the surface of hardened concrete to which a float finish has been applied because a fine coat consisting mainly of calcium carbonate formed by the reaction of calcium hydroxide, which is a hydration product of cement, with the carbon dioxide in the air. Further, there is the problem that the applied resin layers can easily peel off because the production of this fine calcium carbonate coat becomes more pronounced as the water/cement ratio of the cement composition becomes smaller.

In order to solve the abovementioned problems of the art, a method of improving, the penetrating (properties of the primer by applying surface preparation and blast treatments to the surface of hardened concrete is used. However, this method is troublesome, as it requires a considerable amount of time and labor, and presents serious problems such as the deterioration of the working environment due to the noise and dust generated during the surface preparation and blast treatments, and the occurrence of waste, which has to be handled by an industrial waste disposal company.

On the other hand, methods using inorganic acids such as hydrochloric acid, sulfuric acid, nitric acid, etc. in surface treatment agents for hardened concrete have also been proposed to replace the surface preparation and blast treatments. However, these inorganic acids present a safety problem for on-site operators because they are strong acids and their use has not been widespread because of their inadequate performance. Moreover, among the inorganic acids, the use of hydrochloric acid is not desirable because it has the property of corroding the steel in reinforced concrete structures.

Consequently, the problem to be solved by the present invention is to provide, in techniques for forming resin layers on the surface of hardened cement compositions, a method for improving the adhesiveness between hardened cement compositions and resin coating materials, which does not waste time or labor and which does not generate noise and dust, and to provide an agent used in said method.

It has now been found that these problems can all be solved at once by spraying an aqueous solution containing organic acids on to the surface of hardened concrete, and then coating the surface.

Therefore, the present invention relates to a surface reforming method for hardened cement compositions, wherein the surface of a hardened cement composition is treated with an aqueous solution containing organic acid(s), which will react with the surface to produce calcium compounds.

The present invention further relates to a method for forming a resin coating layer on the surface of the hardened cement compositions, wherein the surface of the hardened cement compositions is treated with an aqueous solution containing organic acid(s), which will react with the surface to produce calcium compounds, and a resin coating material is subsequently applied.

The present invention further relates to the abovementioned method, wherein die resin coating material comprises one or more resins selected from the group consisting of urethane resin, epoxy resin, acryl resin and vinyl ester resin.

The present invention also relates to the abovementioned method, wherein the resin coating material is a primer.

The present invention moreover relates to the abovementioned method, wherein the organic acid is one or more acids selected from the group consisting of acetic acid, gluconic acid, formic acid, succinic acid, phosphoric acid and citric acid.

The present invention also relates to a surface reformer for hardened cement compositions used in the abovementioned methods containing organic acid(s), which will react with the surface of the hardened cement compositions to produce calcium compounds.

The present invention further relates to the abovementioned surface reformer wherein the organic acids are one or more acids selected from the group consisting of acetic acid, gluconic acid, formic acid, succinic acid, phosphoric acid and citric acid.

The present invention, changing the fine calcium carbonate coat produced during the cement hardening process into organic calcium salts through a treatment with a surface reformer containing an organic acid which has a higher acidity than carbonic acid, improves the adhesiveness of resin coating materials to the surface of hardened cement compositions by reforming the fine calcium carbonate layer.

In the present invention, spray coating using a sprayer is one means of treating the surface of hardened cement compositions with the aqueous liquid containing an organic acid without, however, limiting it thereto; other methods such as dispersion by a sprinkling can etc. may also be used, as long as the abovementioned aqueous solution is uniformly dispersed on the surface of the hardened cement composition.

Further, the time at which the abovementioned surface reformer is used to treat a hardened cement composition is not particularly limited; however, the treatment preferably takes place after 1 to 7 days and may also be applied to existing hardened cement compositions.

Representative examples of the resin coating materials used in the method according to the present invention include urethane resin, epoxy resin, acryl resin and vinyl ester resin type materials without, how ever, limiting the resin coating material thereto. Moreover, any of the different types of resin coating materials commercially available, such as primers, solvent and non-solvent type materials, 1- or 2-component liquid type materials, etc., can be used. Further, resin mortar, permeable Water absorption-preventing material, permeable solidifying material, mineral-permeable waterproofing material, oil paint, lysine, stucco, etc. can be applied to the resin coating materials used in the method according to the present invention.

The present invention has adopted the method of spraying an aqueous solution containing organic acids on to a hardened cement composition and subsequently applying thereto a resin coating material, even though a resin coating layer is generally formed by applying the resin coating material after a primer has been coated; however, in the present invention, the resin coating material is applied directly on to the surface of the hardened cement composition without applying a primer.

Moreover, the resin coating material is applied after spraying the abovementioned surface reformer, preferably after the humidity in said surface reformer has evaporated. Although the time for coating depends on the environmental conditions, application is preferably 1 to 3 days after spraying the surface reformer. It is preferred that the water content of the cement composition be 8% or less.

The surface reformer according to the present invention is an aqueous solution containing organic acids. Examples of the organic acids used in the surface reformer include acetic acid, salicylic acid, gluconic acid, maleic acid, fumaric acid, formic acid, succinic acid, gallic acid, lactic acid, malic acid, citric acid, malonic acid, tartaric acid, oxalic acid, glycolic acid, propionic acid, butyric acid, acrylic acid, methacrylic acid, benzoic acid, phosphoric acid, etc.; among these however gluconic acid, formic acid, succinic acid, malic acid and citric acid are preferred from the views point of ease of handling and because of the solubility of the calcium salts in water.

The function required of the carboxylic acid according to the present invention is to dissolve the fine calcium carbonate layer by the reaction of the organic acid with cement hydrates such as the calcium carbonate of the surface of the hardened cement composition and to enable the penetration of the primer into the hardened cement composition. Among the organic acids, carboxylic acid generally dissolves the calcium carbonate layer and produces a carboxylate calcium salt. If, however, the solubility of the carboxylate calcium iii water is too small, crystals occur along with the evaporation of the humidity, and because this has an influence on the adhesiveness of the resin coating material, there are cases in which the crystals need to be removed in a separate work process. Therefore, it is desirable that the solubility of the calcium salt of carboxylic acid in water be not too low. The solubility depends on the ambient temperature, the material temperature, etc., and cannot be defined unconditionally; however, a solubility of 0.004 g/100 g or higher is particularly preferred.

Moreover, among the organic acids, there are those with which, even though they are capable of reforming the surface of hardened cement compositions, calcium salt occurs within a short period of a few seconds. However, for the purpose of surface reforming, preferred organic acids are those which are relatively moderate in the production of calcium salt.

In the surface reforming process according to the present invention, ordinarily, it is preferred, from the viewpoint of handling and operating, to spray 80 to 100 g of a surface reformer made from a 5 to 10% aqueous solution of organic acids for 1 m² of the surface of a hardened cement composition; however, the present invention is not particularly limited to this concentration or spraying amount, the optimal concentration or spraying amount can be readily determined by simple experiment. The invention is now further described with reference to the following non-limiting examples.

### EXAMPLES

1. Solubility of Calcium in Water for Different Organic Acids

Table 1 shows the solubility of calcium salts for different organic acids in water in g/100 g of water at a temperature of 25° C.

TABLE 1

| Acid | Solubility of calcium salt |
|---|---|
| Acctic acid | 34.7 (20° C.) |
| Formic acid | 16.1 (0° C.) |
| Salicylic acid | 5.51 (15° C.) |
| Gluconic acid | 3.9 |
| Maleic acid | 2.49 |
| Fumaric acid | 1.56 (30° C.) |
| Succinic acid | 1.29 |
| Malic acid | 0.86 |
| Malonic acid | 0.36 (20° C.) |
| Citric acid | 0.096 |
| Tartaric acid | 0.0023 (0° C.) |
| Oxalic acid | 0.00067 (13° C.) |

2. Test of the Adhesiveness Between a Hardened Cement Composition and a Resin Coating Material
2.1 Adhesiveness for Different Types of Organic Acids

Tests concerning the adhesiveness between mortar and a urethane resin primer were conducted by changing the type of the organic acid, which is the principal component of the surface reformer.

a. Materials Used

Cement: Premix mortar (manufactured by Sho-Bond Chemical Co., Ltd. under the trade name of NS-55)
Resin coating material: Urethane resin primer (manufactured by Sho-Bond Chemical Co., Ltd. under the trade name of NS-U Primer)
   b. Production of the Mortar Test Plate

Mortar test plates were produced by mixing 25 kg of premix mortar to which 4.3 litres of water had been added in a mixer, placing the resulting mixture in a 2 cm deep mould form, and applying a 2 cm thick metal float finish. The plates where cured at a temperature of 20° C.

c. Spraying of the Surface Reformer and Coating with the Primer

100 g/m² of a surface reformer was sprayed on to the surface of a mortar test plate 1 day after it had been produced, a primer was applied the following day, and the adhesion test was performed 3 days after the primer had been applied. The water content of the mortar at the time of coating with the primer was about 7%.

d. Adhesion Test

ξ Cross-cut adhesion test: according to JIS K 5400
   e. Test Results

Table 2 shows that, compared to the case in which a treatment with hydrochloric acid was used, the Examples exhibit very good adhesiveness.

TABLE 2

| | | | Cross-cut adhesion |
|---|---|---|---|
| | Acid | Acid concentration | test evaluation |
| Examples | Gluconic acid | 5% | 10 |
| | Succinic acid | 5% | 10 |
| | Malic acid | 5% | 8 |
| | | 10% | 10 |
| | Citric acid | 5% | 10 |
| | | 10% | 8 |
| Comparative | Hydrochloric | pH = 1.86 | 0 |
| Examples | acid | pH = 1.62 | 0 |

2.2 Adhesiveness for Different Types of Resin Coating Materials

Tests concerning the adhesiveness between mortar and a resin coating material were conducted by using a resin coating material with different components. The test conditions are given below, and the test results are shown in Table 3.

a. Materials Used

Cement composition: Premix mortar (manufactured by Sho-Bond Chemical Co., Ltd. under the trade name of NS-55V)
Surface reformer: 10% aqueous solution of citric acid
Resin coating material: urethane resin-based 1-component liquid primer, urethane resin-based solvent 1-component liquid primer, epoxy resin-based non-solvent 2 component liquid primer and acryl resin-based 2-component liquid primer (all commercially available)
   b. Production of the Mortar Test Plate

Mortar test plates were produced by the same method as described under 2.1 above. The plates where cured at a temperature of 30° C.

c. Spraying of the Surface Reformer and Coating of the Primer

100 g/m² of a surface reformer was sprayed on to the surface of a mortar test plate 1 day after it had been produced, while Comparative Examples were treated by sanding, coated with a primer the following day, and the adhesion test was performed 5 hours after the primer had been coated. The water content of the mortar at the time of coating with the primer was about 5 to 8%.

d. Adhesion Test

ξ Cross-cut adhesion test: according to JIS K 5400
   e. Test Results

Table 3 shows that the Examples using urethane, epoxy and acryl resin-based primers all exhibit good adhesiveness irrespective of the type of the resin used, and that different types of resin coating material such as solvent type and non-solvent type as well as 1-component liquid type and 2-component liquid type etc. all exhibit good adhesiveness.

TABLE 3

| | Cross-cut adhesion test evaluation | | |
|---|---|---|---|
| | | | Surface |
| Resin material | No treatment | Sanding | reforming |
| Urethane resin-based 1 component | 0 | 10 | 10 |
| liquid primer | | | |
| Urethane resin-based solvent 1 | 0 | 10 | 10 |
| component liquid primer | | | |
| Epoxy resin-based non-solvent 2 | 0 | 10 | 10 |
| component liquid primer | | | |
| Acryl resin-based 2 component | 0 | 10 | 10 |
| liquid primer | | | |

2.3 The Age of Hardened Cement Compositions and Adhesiveness

Tests concerning the adhesiveness between mortar and a resin coating material were conducted by varying the age of the hardened cement composition. The test conditions are given below, and the test results are shouts in Table 4.

a. Materials Used

The cement composition and the resin coating materials are identical to those described under 2.1 above, while a 10% aqueous solution of citric acid was used as the surface reformer.

b. Production of the Mortar Test Plate

Mortar test plates were produced by the same method as described under 2.1 above.

c. Spraying of the Surface Reformer and Coating with the Primer

100 g/m² of a surface reformer as sprayed on to the surface of a mortar test plate 1 to 28 days after it had been produced: a primer coating was conducted the following day, and the adhesion test was performed 1 dais after the primer had been coated. The floater content of the mortar at the time of coating with the primer was about 7%.

d. Adhesion Test

ξ Cross-cut adhesion test: according to JIS K 5400
   e. Test Results

From Table 4 it is clear that the age of the hardened cement composition does not have any influence, as good adhesiveness was obtained even in the case in which the surface reformer was sprayed when the hardened cement composition had an ace of 28 days.

TABLE 4

| | |
|---|---|
| | Cross-cut adhesion |
| | test evaluation |
| | Age of the hardened |
| Spraying of the | cement composition: |

| surface reformer | 1 day | 5 days | 7 days | 28 days |
|---|---|---|---|---|
| No | 0 | 0 | 0 | 0 |
| Yes | 10 | 10 | 10 | 10 |

2.4 Simulation of Actual Working Conditions

Tests simulating actual working conditions were conducted as described below. The test conditions are given below, and the test results are shown in Table 5.

a. Materials Used

Cement composition: Premix mortar (manufactured by Sho-Bond Chemical Co., Ltd. under the trade name of NS-55V)
Surface reformer: 5% aqueous solution of citric acid
Resin coating material: urethane resin-based primer (manufactured by Sho-Bond Chemical Co., Ltd. under the trade name of NS-U Primer)
   b. Spraying of the Mortar

After mixing 25 kg of premix mortar to which 4.3 liters of water had been added in a mixer, mortar was sprayed in a 2 m² flat plate with a thickness of 2 cm by using a spray gun; thereafter, the mortar surface was given a finish with a metal float.

c. Spraying of the Surface Reformer and Coating with the Primer

100 g/m² of a surface reformer was sprayed on to the surface of the mortar 1 and 7 days after it had been placed, a urethane primer coating was conducted 1 and 7 days after the surface reformer had been sprayed, and the adhesion test was performed 3 days after the primer had been coated.

d. Adhesion Test

ξ Cross-cut adhesion test: according to JIS K 5400
ξ Bonding test: by means of an adhesion tester
ξ Peeling test: Specimens were produced by further coating a resin coating material after the primer coating had been conducted onto the mortar surface, a leather blade was inserted into parts of the primer after the resin layer had hardened, and the ease with which the resin layer detached from the mortar surface was tested.
   e. Test Results

Table 5 shows that, when a surface reformer was used, good results were obtained with all of the test methods, which are similar to those obtained when sanding was used, and that the ace of the surface reforming layer does not have any influence.

TABLE 5

| | | Age of the | Age at | |
|---|---|---|---|---|
| | Surface | surface | the primer | |
| Test method | treatment | treatment | coating | Test result |
| Cross-cut | None | — | 2 days | 0 point |
| adhesion | Sanding | 1 day | 2 days | 10 points |
| test | Reformer | 1 day | 2 days | 10 points |
| | | | 8 days | 10 points |
| | Reformer | 7 days | 8 days | 10 points |
| | | | 14 days | 10 points |
| Bonding | None | — | 2 days | 0.49-0.67 N/mm² |
| test | Sanding | 1 day | 2 days | 1.80-2.27 N/mm² |
| | Reformer | 1 day | 2 days | 1.53-1.75 N/mm² |
| | | | 8 days | 2.25-2.95 N/mm² |
| | Reformer | 7 days | 8 days | 1.84-2.17 N/mm² |
| | | | 14 days | 2.48-3.82 N/mm² |
| Peeling | None | — | 2 days | peeled during |
| test | | | | cutting |
| | Sanding | 1 day | 2 days | did not peel easily |
| | Reformer | 1 day | 2 days | idem |
| | | | 8 days | idem |
| | Reformer | 7 days | 8 days | idem |
| | | | 14 days | idem |

According to the present invention, the method for improving the adhesiveness of resin coating materials for reforming the surface of hardened cement compositions, the method for forming a resin coating layer on a hardened cement composition whose surface has been reformed, and the surface reformer used in said methods have the following effects:
1. improving the adhesiveness between hardened cement compositions and resin coating materials, thus preventing the peeling of the resin layer and achieving the purpose of corrosion resistance, waterproofing, decoration, etc.;
2. enabling to spray the surface reformer; thus greatly reducing working time without wasting time and labor; and
3. being free of noise and dust generation, thus improving the working environment without generating industrial waste.

1. A method of reforming the surface of a hardened cement composition comprising treating the surface of the hardened cement composition with an aqueous solution containing at least one organic acid, which reacts with the surface to produce calcium compounds.

2. A method for forming a resin coating layer on the surface of a hardened cement composition comprising treating the surface of the hardened cement composition with an aqueous solution containing at least one organic acid, which reacts with the surface to produce calcium compounds, and subsequently applying a resin coating material.

3. The method of claim 2, wherein the resin coating material comprises one or more resins selected from the group consisting of urethane resin, epoxy resin, acryl resin and vinyl ester resin.

4. The method of claim 3, wherein the resin coating material is a primer.

5. The method of claim 1 wherein the organic acid is at least one acid selected from the group consisting of acetic acid, gluconic acid, formic acid, succinic acid, phosphoric acid and citric acid.

6. A surface reformer for hardened cement compositions which comprises organic acid, which reacts with the surface of the harden cement compositions to produce calcium compounds.

7. The surface reformer of claim 6 wherein the organic acid is at least one acid selected from the group consisting of acetic acid, gluconic acid, formic acid, succinic acid, phosphoric acid and citric acid.

8. The method of claim 2 wherein the resin coating material is a primer.

9. The method of claim 2 wherein the organic acid is at least one acid selected from the group consisting of acetic acid, gluconic acid, formic acid, succinic acid, phosphoric acid and citric acid.
